(19) United States
(12) Patent Application Publication
(10) Pub. No.: US 2007/0060004 A1
(43) Pub. Date: Mar. 15, 2007

(54) Natural polymer mat and manufacturing method thereof

(76) Inventor: Hsu Tang Su-Tuan, Tao Yuan City (TW)

Correspondence Address: TROXELL LAW OFFICE PLLC, SUITE 1404, 5205 LEESBURG PIKE, FALLS CHURCH, VA, 22041, US

(21) Appl. No.: 11/225,003

(22) Filed: Sep. 14, 2005

(51) Int. Cl. B32B 5/02

(52) U.S. Cl. 442/152

(57) ABSTRACT

A natural polymer mat, which is biodegradable, and manufacturing method thereof are disclosed. The present method includes the steps of: (a) providing and flattening a natural textile, which is used as a substrate, having a first surface and a second surface; (b) coating the flattened natural textile with natural high polymer raw material regulated according to a predetermined formula contained in a cotainer; (c) pressing the natural textile with a presser so as to have the first surface coated with the most amount of natural high polymer raw material and the second surface coated with few amount natural high polymer raw material; (d) drying the natural high polymer raw material at a predetermined high temperature, and (e) rapidly cooling down to consolidate the natural high polymer material.

### BACKGROUND OF THE INVENTION

1. Field of the Invention

The present invention relates to a natural polymer mat and manufacturing method thereof, and more particularly, to a mat made by a natural textile, instead of traditional industrial, and natural polymer used as stuff, which are biodegradable by the microorganism in the soil, rather than traditional plastic.

2. Description of the Prior Art

Although industrialized society brings the people with convenient lifestyle, the accompanying problem is the excessive use of plastic products made from petroleum. Plastic products are hard to be decomposed and thus cause environmental pollution. The poll conducted by Gallop indicates that in 2002 the disposed plastic trash accounts for 9.8% in the solid trash amounting to 2.16 hundred million in America, and even 15% in Taiwan.

At present, it is inevitable to use polluting plastic, such as polyvinyl chloride (PVC), in the technology for manufacturing anti-slide mats or exercise mats. Therefore, there is a need to develop a novel mat without using plastic and keep the desired characteristics of plastic.

### SUMMARY OF THE INVENTION

The present invention provides a natural polymer mat and the manufacturing method thereof, which uses natural polymer material as the stuff to replace plastic. The present natural polymer mat is environmental-friendly and still maintains the desired characteristics of plastic.

However, the commonly used high polymer materials, such as amylum or cellulose, have no satisfying plasticity as plastic, such as polyvinyl chloride or PVC. Meanwhile, compared with plastic, it is hard to properly control their physical characteristic. Therefore, conversion of physical property and precise control of manufacturing process are required to manufacture the present natural polymer mat, can be used as anti-slide mats or exercise mats.

The present invention discloses a method for manufacturing a natural polymer mat, which is biodegradable. The present method includes the steps of: (a) providing and flattening a piece of natural textile; (b) coating the flattened natural textile with natural high polymer raw material regulated according to a predetermined formula contained in a container; (c) drying the natural high polymer raw material at a predetermined high temperature; and (d) rapidly cooling down to consolidate the natural high polymer material.

The present invention discloses a natural polymer mat, including a piece of natural textile, having an upper surface and a lower surface, and a natural polymer material layer, coated on the upper surface and the lower surface. The formula for regulating the natural polymer material layer includes a large percentage of natural high polymer raw material, a tiny percentage of yeast, a small percentage of pure water, resin and crosslinking agent.

### BRIEF DESCRIPTION OF THE DRAWINGS

The foregoing aspects and many of the attendant advantages of this invention will become more readily appreciated and better understood by referencing the following detailed description, when taken in conjunction with the accompanying, wherein:

FIG. 1 illustrates the method of forming the present natural polymer mat according to the present invention;

FIG. 2 illustrates the flow chart of forming the natural polymer raw material according to the present invention; and

FIG. 3 illustrates the perspective view of the present natural polymer mat according to the present invention.

### DESCRIPTION OF THE PREFERRED EMBODIMENT

The present invention discloses a natural polymer mat, in which a natural textile is used as a substrate, and manufacturing method thereof. The natural textile is coated with natural polymer raw material, in turn, pressed, dried, rapidly cooled down and consolidated.

However, the commonly used high polymer materials, such as amylum or cellulose, have no satisfying plasticity as plastic. Meanwhile, compared with plastic, it is hard to properly control their physical characteristic. Therefore, conversion of physical property and precise control of manufacturing process are required to manufacture the present natural polymer mat, can be used as anti-slide mats or exercise mats.

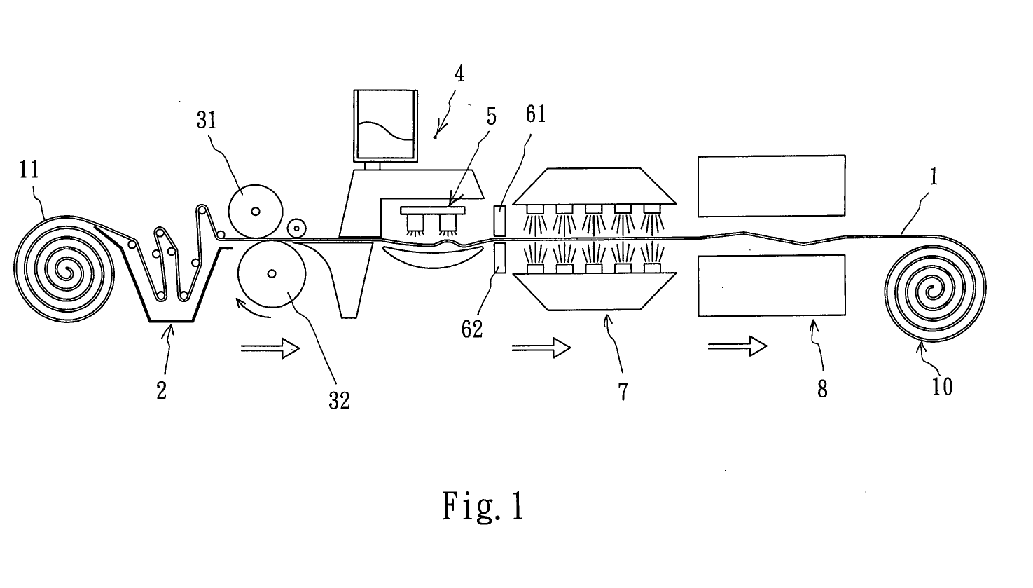

Please refer to FIG. 1, which depicts the method for manufacturing the present natural polymer mat 1. (a) First, a natural textile 11, having a first surface and a second surface, is provided and conveyed. (b) A thermal flattener 2 is used to flatten the natural textile 11 by heat. (c) At least two rollers 31 and 32, arranged on different levels are provided. The natural textile 11 passes through the region between the rollers 31 and 32, and leans against the rollers 31 and 32 so that the natural textile 11 is tightened and flattened. (d) The flattened natural textile 11 is coated with natural high polymer material, regulated according to a predetermined formula, contained in a container 4 located above the two surfaces of the natural textile 11, to obtain the natural textile 11 coated with natural high polymer material, which is semi-finished. (e) The semi-finished natural textile 11 coated with natural high polymer material is pressed by a presser 5 to have the natural textile 11 coated with the most amount of the natural high polymer material. The presser 5 can be a fan module, which blows the natural high polymer material and thus has the natural high polymer raw material distribute along the texture of the natural textile 11 so as to obtain a flexible surface 12, also the first surface. On the other hand, the second surface 13 is coated with few amount of the natural high polymer raw material and thus the texture of the natural textile 11 on the second surface 13 is maintained. (f) A first thickness detector 61 and a second thickness detector 62 are provided and arranged on different levels. The natural textile 11 passes through the region between the first thickness detector 61 and the second thickness detector 62. The first thickness detector 61 and the second thickness detector 62 are used to detect the thickness of the natural high polymer raw material coated on the first surface 12 and the thickness of the natural high polymer raw material coated on the second surface 13, respectively. (g) A heater module 7, is provided to dry the natural high polymer material at a pre-determined high temperature. The pre-determined high temperature can be 220 degree Celsius. (h) A cooling area 8 is provided to cool down, at a pre-determined low temperature, to consolidate the natural high polymer material and thus finish the natural high polymer mat 1. The pre-determined low temperature can be 5 degree Celsius. (i) The natural high polymer mat 1 is rolled up to obtain a roll-type natural high polymer mat 10. The natural textile can be linen, cotton, bamboo, carbon fiber or the like.

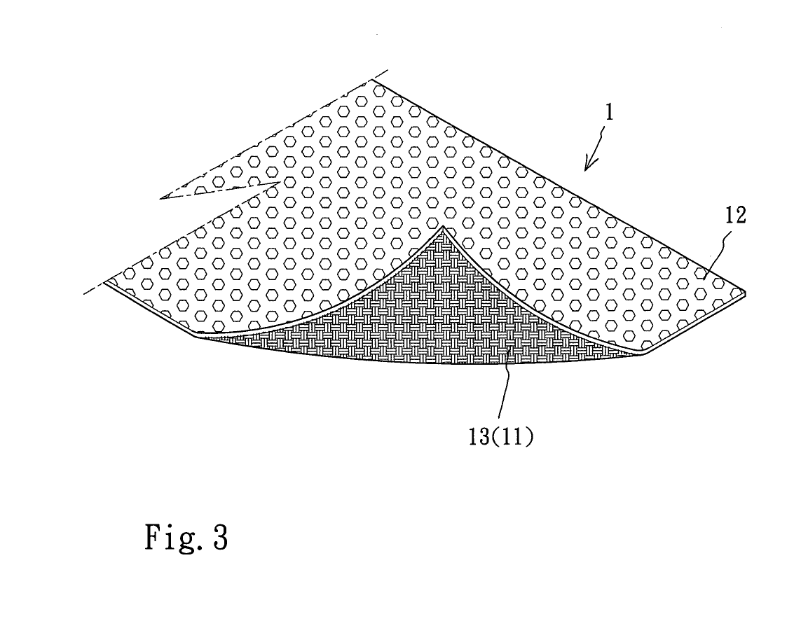

As shown in FIG. 3, the natural high polymer mat 1 includes the natural textile 11 having a first surface and a second surface, each having a natural high polymer layer coated thereon, respectively. The first surface of the natural textile 11 is coated with the most amount of the natural high polymer layer so as to form the flexible surface 12. On the other hand, the second surface of the natural textile 11 is coated with few amount of the natural high polymer layer so as to form the textured surface 13 which exposes the original texture of the natural textile 11.

The natural polymer layers are made according to a pre-determined formula consisting of a large percentage, about 70%, of the natural textile 11, such as amylum, plant fiber or cellulose, a tiny percentage, about 0.5%, of yeast, a small percentage, about 20%, of pure water, a small amount, about 6%, of resin and a small amount, about 3.5%, of crosslinking agents. Of course, the natural textile 11 can be replaced by PER if required.

The method for forming the formula of the natural polymer mat 1 includes the following steps. First, in step S1, the large percentage of natural polymer material (about 70%), such as amylum, the tiny percentage of yeast (about 1%) and the small percentage of pure water (about 20%) are mixed. Then, in step S4, the small percentage of resin (about 5%) is added into the mixture of natural polymer material, amylum, yeast and pure water. Thereafter, in step S5, the small percentage of crosslinking agent (about 4%) is added the mixture of natural polymer material, amylum, yeast, pure water as well as resin, and then further mixed properly.

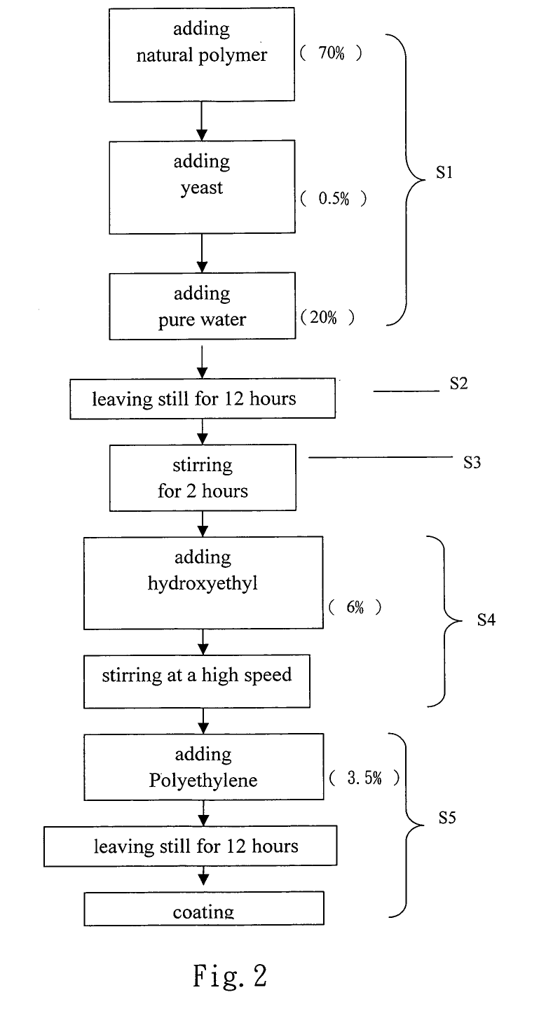

Please refer to FIG. 2, which depicts the flowchart of forming the natural polymer material according to the formula. In step S1, the large percentage of natural polymer, the tiny percentage of yeast and the small percentage of pure water are mixed in order. In step S2, the above materials are left still for about 12 hours to quench or ferment them. In step S3, the above materials are stirred and mixed, in a high speed, for about 2 hours using a single-screw extruder. In step S4, the small percentage of resin, such as hydroxyethyl, is added and further mixed in a high speed. In step S5, the small percentage of crosslinking agent, such as polyethylene, is added and then left still for about 12 hours so as to obtain the natural polymer raw material.

Because the natural textile 11, such as linen, is used as the substrate, the present natural polymer mat 1 presents the natural texture that the industrial meshed cloth cannot provide. Further, the natural textile 11 is soaked in the container 4. Thereafter, the fan module 5 is used to squeeze the natural polymer raw material so that the first surface of the natural textile is coated with most amount of the natural polymer material. By way of squeeze, the natural polymer raw material distributes along the texture of the natural textile 11 and thus the flexible surface 12, which has an irregular granular structure, is obtained. In addition, the second surface of the natural textile 11 is coated with few amount of the natural high polymer layer so as to form the textured surface 13, also the second surface, which exposes the original texture of the natural textile 11.

Unlike the present invention, the traditional mat uses a piece of meshed cloth as the substrate, which is completely covered by plastic material and thus cannot present the texture of the substrate. In the present invention, via the container 4 and the fan module 5, the amounts of natural polymer raw material coated on the first surface and the second surface of the natural textile are different. In this way, the first surface of the natural textile 11 is coated with the most amount of the natural high polymer layer so that the flexible surface 12 is obtained. On the other hand, the second surface of the natural textile 11 is coated with few amount of the natural high polymer layer so that the textured surface 13, which exposes the original texture of the natural textile 11, is obtained. That is, in the present mat, the first surface and the second surface are asymmetric. In sum, the natural polymer mat and the manufacturing method thereof of the present invention include the following advantages. First, because the present mat uses a natural textile as the substrate, instead of traditional industrial meshed cloth and the natural polymer raw material, instead of plastic material, to cover the substrate, the present mat is fully composed of environmental protection material and biodegradable. That is, the present mat can be decomposed by microorganisms after disposal and become inorganic matters, such as carbon dioxide or water and be fully absorbed by the environment. Second, besides environmental protection, the present mat still possesses the same level of tenacity, ductility, flatness and machinability as the industrial meshed cloth. Meanwhile, the present mat has the same level of plasticity and flexibility as the traditional plastic. Third, because the present mat uses natural polymer material as stuff, instead of plastic, the present mat does not discomfort the human skin. Fourth, by way of the distribution technology disclosed in the present invention, in the present mat, the first surface, the flexible surface 12, and the second surface, the textured surface 13, are asymmetric.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for manufacturing a natural polymer mat, comprising the steps as follows:
providing and flattening a natural textile, having a first surface and a second surface;
coating the flattened natural textile with natural polymer raw material, regulated according to a pre-determined formula, contained in a container;
pressing the flattened natural textile coated with the natural polymer raw material, via a presser, so as to have the most amount of the natural polymer raw material coated on the first surface and few amount of the natural polymer raw material coated on the second surface;
drying the natural polymer raw material at a predetermined high temperature; and
cooling down the natural polymer raw material so as to consolidate the natural polymer raw material and obtain the natural polymer matcrosslinking agent.

2. The method according to claim 1, wherein the step of flattening the natural textile is achieved by heating.

3. The method according to claim 1, wherein after the step of flattening the natural textile and before the step of coating further comprises:
providing a presser, having two rollers arranged on different levels, to further flatten and tighten the natural textile coated with the natural polymer raw material.

4. The method according to claim 1, wherein the presser is a fan module, which blows the natural high polymer raw material and has the natural high polymer raw material distribute along the texture of the natural textile so as to obtain a flexible surface, and the texture of the natural textile on the second surface is exposed.

5. The method according to claim 1, wherein after the step of pressing and before the step of drying further comprises:
detecting the thickness of the natural polymer raw material coated on the first surface and the thickness of the natural polymer raw material coated on the second surface via a first thickness detector and a second thickness detector, respectively.

6. The method according to claim 1, wherein the natural textile is chosen from the group consisting of linen, cotton, bamboo and carbon fiber.

7. The method according to claim 1, wherein the natural polymer raw material is made from natural high polymer material, yeast, pure water, resin and crosslinking agent.

8. The method according to claim 1, wherein the formula is regulated according to the following steps, comprising:
mixing the natural polymer, the yeast and the pure water in order to obtain a mixture of the natural polymer, the yeast and the pure water;
leaving the mixture still for about a first period of time so as to quench and ferment;
adding the resin into the mixture after stirring the resin and the mixture for a second period of time;
adding the crosslinking agent after stirring; and
leaving the mixture still.

9. The method according to claim 8, wherein after the step of adding the crossliking agent the mixture is left still for about 12 hours.

10. The method according to claim 7, wherein the resin is hydroxyethyl.

11. The method according to claim 7, wherein the natural polymer material is amylum, plant fiber or cellulose.

12. The method according to claim 1, wherein the crosslinking agent is carbonate.

13. The method according to claim 1, wherein after the step of cooling down the natural polymer raw material further comprises:
rolling up the natural polymer so as to obtain a roll-type natural polymer mat.

14. A natural polymer mat, comprising:
a natural textile, having a first surface and a second surface; and
a natural polymer material layer, coated on the first surface, forming a flexible surface and exposing texture of the natural textile on the second surface.

15. The natural polymer mat according to claim 1, wherein the natural textile is chosen from the group consisting of linen, cotton, bamboo and carbon fiber; and wherein the natural polymer material is amylum, plant fiber or cellulose
